(19) United States
(12) Patent Application Publication
(10) Pub. No.: US 2009/0190805 A1
(43) Pub. Date: Jul. 30, 2009

(54) SYSTEM AND METHOD FOR FINGERPRINT RECOGNITION

(75) Inventors: Shih-Hsin CHANG, Taipei Hsien (TW); Chan-Ping PO, Taipei Hsien (TW)

Correspondence Address: MCNEES WALLACE & NURICK LLC, 100 PINE STREET, P.O. BOX 1166, HARRISBURG, PA, 17108-1166, US

(73) Assignee: ACER INCORPORATED, Taipei Hsien (TW)

(21) Appl. No.: 12/194,010

(22) Filed: Aug. 19, 2008

(30) Foreign Application Priority Data
Jan. 29, 2008 (TW) 097103245

(51) Int. Cl. G06K 9/00; G06F 17/30; G06F 7/04

(52) U.S. Cl. 382/124; 726/27; 726/16

(57) ABSTRACT

A fingerprint recognition system for an electronic device includes an input module, a computational module, and a database. The input module receives initial and subsequent fingerprint templates, and a unique character code. The computational module calculates a unique key for the initial fingerprint template on the basis of the character code to establish security, and a check key for the subsequent fingerprint template on the basis of the character code. The computational module removes the security for the electronic device when the check key matches the unique key. The database stores the initial fingerprint template and the unique key. An electronic device including the fingerprint recognition system, and a fingerprint recognition method are also disclosed.

### CROSS-REFERENCE TO RELATED APPLICATION

This application claims priority of Taiwanese Application No. 097103245, filed on Jan. 29, 2008.

### BACKGROUND OF THE INVENTION

1. Field of the Invention

The present invention relates to fingerprint recognition technology. More particularly, the present invention relates to a fingerprint recognition system, a fingerprint recognition method, and an electronic device including the fingerprint recognition system.

2. Description of the Related Art

There are many approaches to limiting access to information stored in electronic devices. As an example, a Trusted Platform Module (TPM) chip may be installed in an electronic device. When desiring to encrypt or decrypt information, the user enters a key that is stored in the TPM chip, and if the key is valid, the TPM chip allows the user to carry out the desired operation. However, a TPM chip increases the cost of the electronic device in which it is installed. Also, the key must be memorized which is burdensome to the user. If the user writes the key down so as to relieve this burden, a security hole is created.

An alternative approach to providing security to information stored in electronic devices is that in which biometrics are used to identify specific people. One common application of biometrics involves the use of fingerprint recognition technology in an electronic device, such as a notebook computer.

When a notebook computer is equipped with a fingerprint recognition system, the system first establishes security for software installed in the notebook computer. This is achieved by the user inputting a fingerprint using a fingerprint scanner, after which the system associates the obtained fingerprint with the protected software and stores the obtained fingerprint. During a process of removing security for the software, the user inputs his or her fingerprint (of the same finger on the same hand as when security was established), and this subsequently obtained fingerprint is compared with the stored fingerprint. The security of the protected software is removed if there is a match.

The conventional electronic device equipped with the conventional fingerprint identification system has the following drawbacks:

1. During the process of establishing security, a template is created corresponding to the obtained fingerprint. This template is stored in a database and the database, in turn, is stored as an electronic file in a storage medium of the electronic device, such as a hard drive of the electronic device. A flaw in the conventional system is that a hacker can replace the electronic file of the database with an electronic file of a database from another computer, thereby allowing the hacker to access the protected software while preventing authorization of the original owner of the electronic device.

2. During the process of removing security, the conventional fingerprint recognition system accepts input of a fingerprint from any device that is connected to any one of the input ports of the electronic device. So, for example, a hacker may obtain the fingerprint of the true user through illicit means, and then input the same through a device connected to any one of the external universal serial bus ports of the electronic device and thereby defeat the fingerprint recognition system.

### SUMMARY OF THE INVENTION

Therefore, an object of this invention is to provide a fingerprint recognition system, a fingerprint recognition method, and an electronic device including the fingerprint recognition system that can overcome the above drawbacks of the prior art.

According to one aspect of this invention, the fingerprint recognition system for an electronic device comprises an input module, a computational module, and a database. The input module receives an initial fingerprint template, a subsequent fingerprint template, and a unique character code. The computational module calculates a unique key for the initial fingerprint template on the basis of the character code when first establishing security, calculates a check key for the subsequent fingerprint template on the basis of the character code at a subsequent period, and removes the security for the electronic device when the check key matches the unique key. The database stores the initial fingerprint template and the unique key.

According to another aspect of this invention, in the fingerprint recognition method for an electronic device, a fingerprint template and a unique character code are first received. Next, it is determined whether the fingerprint template is already present in a database. If not, a unique key corresponding to the fingerprint template is calculated for fingerprint verification on the basis of the character code to establish security for the electronic device. Finally, the fingerprint template and the unique key are stored in the database.

According to still another aspect of this invention, the fingerprint recognition method for an electronic device comprises first receiving a fingerprint template and a unique character code. Next, it is determined whether the fingerprint template is already present in a database. If so, a check key corresponding to the fingerprint template is calculated for fingerprint verification on the basis of the character code.

According to yet another aspect of this invention, the electronic device using fingerprint recognition to establish or remove security of protected software comprises a recording unit, a fingerprint-obtaining unit, and a processing unit. The recording unit stores a device identification of the electronic device. The fingerprint-obtaining unit receives an initial fingerprint and a subsequent fingerprint, and generates corresponding initial and subsequent fingerprint templates. The processing unit comprises a fingerprint recognition system which, in turn, comprises an input module, a computational module, and a database. The input module receives the initial fingerprint template, the subsequent fingerprint template, and the device identification. The computational module calculates a unique key corresponding to the initial fingerprint template using the device identification, and a check key corresponding to the subsequent fingerprint template using the device identification. The computational module removes the security for the protected software when the check key matches the unique key. The database stores the initial fingerprint template and the unique key. In this aspect, operation of the protected software by the processing unit is restricted when the security is established and permitted when the security is removed.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of an electronic device according to a preferred embodiment of the present invention;

FIG. 2 is a schematic block diagram of a fingerprint recognition system according to a preferred embodiment of the present invention;

FIG. 3 is a flowchart of a fingerprint recognition method according to a preferred embodiment of the present invention, illustrating the steps involved to establish security for protected software; and

FIG. 4 is a flowchart of the fingerprint recognition method according to the preferred embodiment of the present invention, illustrating the steps involved to remove security for the protected software.

### DETAILED DESCRIPTION OF THE PREFERRED EMBODIMENT

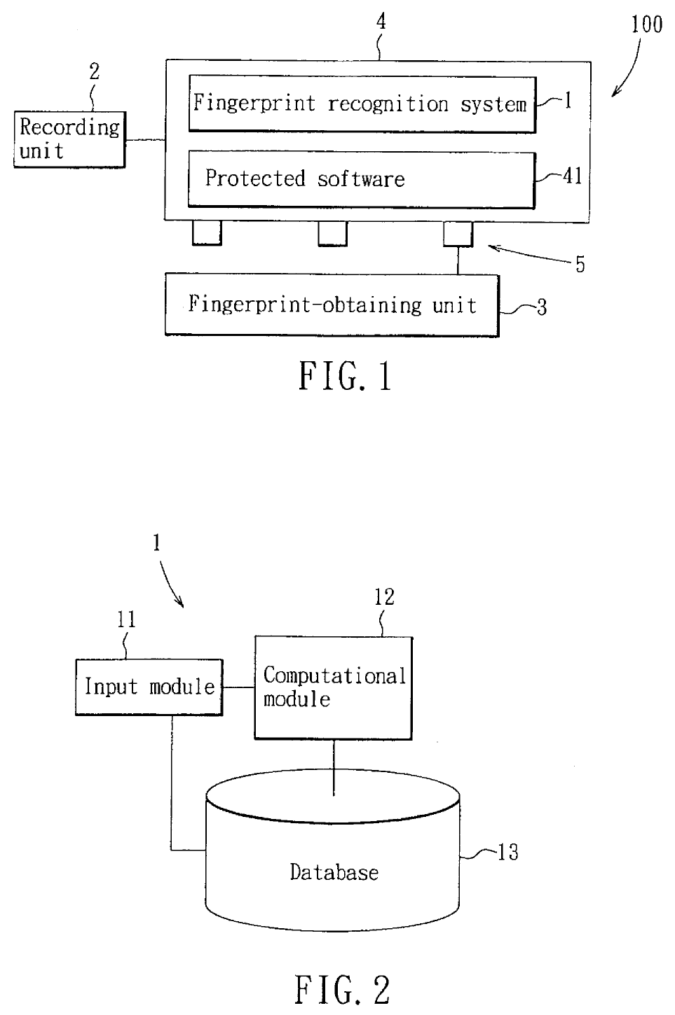

Referring to FIG. 1, an electronic device 100 according to a preferred embodiment of the present invention uses fingerprint recognition to set up or remove security of protected software 41. The electronic device 100 may be, for example, a notebook computer. The electronic device 100 includes a recording unit 2, a fingerprint-obtaining unit 3, and a processing unit 4.

The recording unit 2 stores a unique character code and a reference code. The recording unit 2 may store other content needed for operation of the electronic device 100, such as a basic input/output system (BIOS) of the electronic device 100. As an example, the recording unit 2 may be a read-only memory (ROM) of the electronic device 100.

In the preferred embodiment, the unique character code is a device identification (ID) of the electronic device 100, and the reference code is a platform ID of the electronic device 100. The device ID and platform ID are unique identifications that are given to the electronic device 100 at the time of manufacture. Typically, the device ID is recorded in the ROM, i.e., the recording unit 2, of the electronic device 100, and the user is unable to determine what the device ID is. The platform ID may be a serial number of the electronic device 100, and in addition to being stored in the recording unit 2, may also be printed on the electronic device 100. The platform ID allows those at the factory to quickly ascertain the manufacturing date of the electronic device 100 and the factory where the electronic device 100 was made, and is often used for quality control purposes.

The fingerprint-obtaining unit 3 allows a user to input an initial fingerprint and a subsequent fingerprint, and generates an initial fingerprint template of the initial fingerprint and a subsequent fingerprint template of the subsequent fingerprint. The initial and subsequent fingerprint templates are generated in accordance with existing methods of extracting fingerprint features. In the preferred embodiment, the fingerprint-obtaining unit 3 is an internally mounted fingerprint-sensing device.

The processing unit 4 is coupled to the recording unit 2 and the fingerprint-obtaining unit 3, and includes a fingerprint recognition system 1 and the protected software 41.

Referring additionally to FIG. 2, the fingerprint recognition system 1 includes an input module 11, a computational module 12, and a database 13. The fingerprint recognition system 1 may be implemented using hardware, such as a dedicated chip, or may be implemented by software. In the preferred embodiment, the fingerprint recognition system 1 is implemented through software that is included in and executed by the processing unit 4.

The input module 11 of the fingerprint recognition system 1 receives the initial fingerprint template and the subsequent fingerprint template from the fingerprint-obtaining unit 3, and the device ID from the recording unit 2.

The computational module 12 is coupled to the input module 11. The computational module 12 calculates a unique key for the initial fingerprint template on the basis of the device ID during an initial procedure to establish security for the protected software 41. The computational module 12 further calculates a check key for the subsequent fingerprint template on the basis of the device ID during a subsequent procedure. The computational module 12 removes the security for the protected software 41 if the check key matches the unique key. In particular, operation of the protected software 41 by the processing unit 4 is restricted when the security is established for the protected software 41 by the fingerprint recognition system 1, and operation of the protected software 41 by the processing unit 4 is permitted when the security is removed for the protected software 41 by the fingerprint recognition system 1.

The unique key and the check key may be generated by the computational module 12 using symmetric encryption (e.g., DES encryption) or asymmetric encryption (e.g., RSA encryption) to thereby encrypt the data of the initial and subsequent fingerprint templates.

In one embodiment, the computational module 12 of the fingerprint recognition system 1 calculates the unique key and the check key, both on the basis of the device ID and the platform ID.

In another embodiment, the electronic device 100 further includes a plurality of universal serial bus (USB) ports 5, and the fingerprint-obtaining unit 3 is coupled to the processing unit 4 through one of the USB ports 5 having a USB port number associated therewith. In this embodiment, the computational module 12 of the fingerprint recognition system 1 calculates the unique key and the check key, both on the basis of the device ID and the USB port number of the USB port 5 to which the fingerprint-obtaining unit 3 is coupled.

By using the USB port number of the USE port 5 to which the fingerprint-obtaining unit 3 is coupled to calculate each of the unique key and the check key, it is ensured that only the internally mounted fingerprint-obtaining unit 3 may be used to obtain fingerprints from the user. For example, if it is assumed that the fingerprint-obtaining unit 3 is coupled to a USB port 5 that is assigned a particular USB port number (x), since the unique key is generated at least partly on the basis of this particular USB port number (x), a different fingerprint-obtaining unit connected to a different USB port 5 that would be assigned a different USB port number (y) would result in the generation of a check key that does not match the unique key.

The unique key and the check key may be generated on the basis of any one or any combination of the device ID of the electronic device 100, the platform ID of the electronic device 100, and the USB port number of the USE port 5 to which the fingerprint-obtaining unit 3 is coupled.

The database 13 of the fingerprint recognition system 1 is coupled to the computational module 12 and the input module 11, and stores the initial fingerprint template and the unique key.

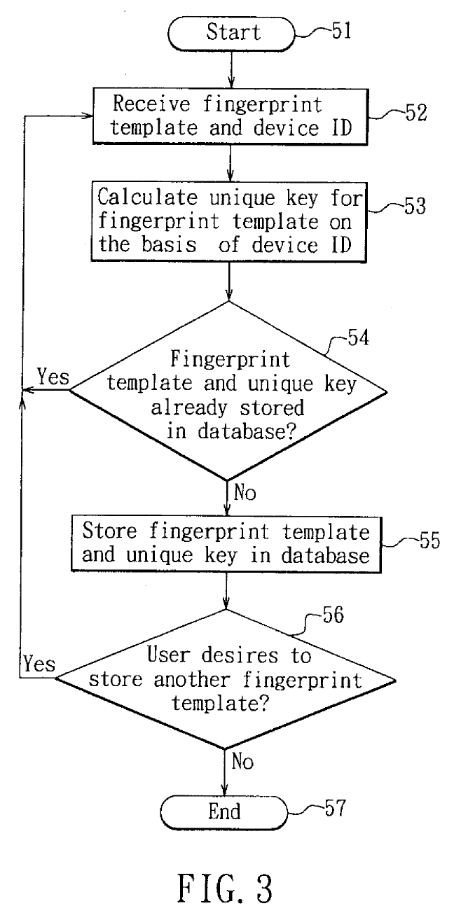

FIG. 3 is a flowchart of a fingerprint recognition method according to a preferred embodiment of the present invention, illustrating the steps involved to establish security for the protected software 41.

First, in step 51, the fingerprint recognition system 1 is started by the user either directly, such as by the user directly initiating the process to establish security for the protected software 41, or indirectly, such as by the user running software for which security has not yet been established.

Next, in step 52, the input module 11 of the fingerprint recognition system 1 receives a fingerprint template from the fingerprint-obtaining unit 3 and a device ID of the electronic device 100 from the recording unit 2.

Subsequently, in step 53, the computational module 12 of the fingerprint recognition system 1 calculates a unique key for the fingerprint template on the basis of the device ID. In other embodiments, the unique key may be calculated on the basis of any one or any combination of the device ID of the electronic device 100, the platform ID of the electronic device 100, and the USB port number of the USB port 5 to which the fingerprint-obtaining unit 3 is coupled.

Next, in step 54, the computational module 12 determines whether the fingerprint template and the unique key are already stored in the database 13. If so, the fingerprint template and the unique key are not stored, and the flow returns to step 52 in which the input module 11 waits to receive another fingerprint template.

In some embodiments, step 54 may entail a determination of whether a fingerprint template (i.e., any fingerprint template) is already present in the database 13 as a means of ascertaining whether the process is in a stage of establishing security for the protected software 41 (when there is no existing fingerprint template in the database 13) or in a stage of removing security for the protected software 41 (when there is an existing fingerprint template in the database 13). In the case where it is determined that the process is in a stage of removing security for the protected software 41, the subsequent steps may involve calculating a check key for the newly obtained fingerprint template and comparing the check key with the unique key of the previously obtained, existing fingerprint template so as to remove security when there is a match.

If the fingerprint template and the unique key are not stored in the database 13 in step 54, the computational module 12 stores the fingerprint template and the unique key in the database 13 in step 55. In some embodiments, the unique key may be used to correspond to the database 13, such that when the computational module 12 requires access to the fingerprint template in the database 13, it is necessary to first undergo verification of the unique key.

Subsequently, in step 56, the computational module 12 of the fingerprint recognition system 1 performs control such that the user is queried as to whether he or she desires to store another fingerprint template. If so, the input module 11 waits to receive another fingerprint template in step 52. If not, in step 57, the process of establishing security for the protected software 41 is ended.

Hence, security is established for the protected software 41 through the above process. For example, if the protected software 41 is application software, the application software is unable to be executed unless the security is first removed. If the protected software is an operating system, the user is unable to log on to the operating system or access a particular data file through the operating system unless the security is first removed.

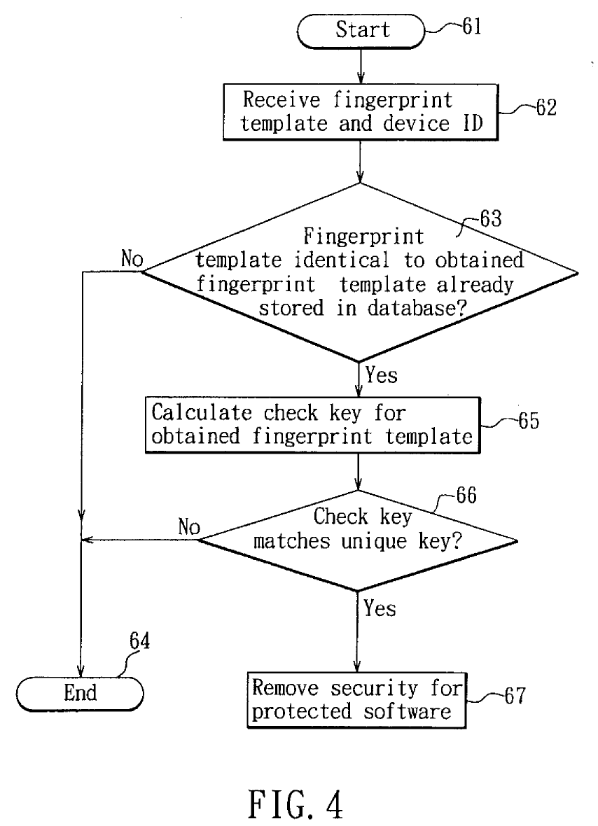

FIG. 4 is a flowchart of the fingerprint recognition method according to the preferred embodiment of the present invention, illustrating the steps involved to remove security for the protected software 41.

First, in step 61, the fingerprint recognition system 1 is started by the user either directly, such as by the user directly initiating the process to remove security for the protected software 41, or indirectly, such as by the user attempting to use the protected software 41.

Subsequently, in step 62, the input module 11 of the fingerprint recognition system 1 receives a fingerprint template from the fingerprint-obtaining unit 3 and a device ID of the electronic device 100 from the recording unit 2.

Next, in step 63, the computational module 12 determines whether a fingerprint template identical to the obtained fingerprint template is already stored in the database 13. If not, then this is an indication that the fingerprint template is not a valid fingerprint template for removing security for the protected software 41 and the process for removing security is ended in step 64.

If a fingerprint template identical to the obtained fingerprint template is already stored in the database 13 in step 63, the computational module 12 calculates a check key for the obtained fingerprint template on the basis of the device ID instep 65. In other embodiments, the check key may be calculated on the basis of any one or any combination of the device ID of the electronic device 100, the platform ID of the electronic device 100, and the USB port number of the USB port 5 to which the fingerprint-obtaining unit 3 is coupled. Next, in step 66, the computational module 12 checks whether the check key matches the unique key for the fingerprint template. If so, in step 67, the computational module 12 removes the security for the protected software 41, such that operation of the protected software 41 by the processing unit 4 is permitted. However, if the check key does not match the unique key, then this indicates that the fingerprint template is not valid and the computational module 12 ends the process of removing security for the protected software 41 in step 64.

The present invention as described above has the following advantages:

1. Since each electronic device has a distinct device ID and a distinct platform ID, the unique key generated for each electronic device is different. By performing authentication using the unique key as described above, hackers are unable to use a method by which the database 13 is substituted in an effort to execute and access the protected software 41.

2. The USB port number may be included in the unique key, such that hackers are unable to use a substitute fingerprint-obtaining unit to input an illicitly obtained fingerprint.

3. The present invention provides a high level of security without incurring the costs associated with installing a TPM chip in the electronic device 100.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A fingerprint recognition system for an electronic device, comprising:
an input module for receiving an initial fingerprint template, a subsequent fingerprint template, and a unique character code;
a computational module coupled to said input module, said computational module calculating a unique key for the initial fingerprint template on the basis of the character code during an initial procedure to establish security for the electronic device, calculating a check key for the subsequent fingerprint template on the basis of the character code during a subsequent procedure, and removing the security for the electronic device when the check key matches the unique key; and
a database coupled to said computational module and said input module, and storing the initial fingerprint template and the unique key.

2. The fingerprint recognition system of claim 1, wherein said input module further receives a reference code, said computational module calculating the unique key and the check key, both on the basis of the character code and the reference code.

3. The fingerprint recognition system of claim 1, wherein said input module further receives a universal serial bus port number, said computational module calculating the unique key and the check key, both on the basis of the character code and the universal serial bus port number.

4. The fingerprint recognition system of claim 1, wherein the character code is a device identification stored in the electronic device.

5. A fingerprint recognition method for an electronic device, comprising:
(a) receiving a fingerprint template and a unique character code;
(b) determining whether the fingerprint template is already present in a database;
(c) calculating a unique key corresponding to the fingerprint template for fingerprint verification on the basis of the character code when the fingerprint template is not stored in the database to establish security for the electronic device; and
(d) storing the fingerprint template and the unique key in the database.

6. The fingerprint recognition method of claim 5, further comprising:
(e) receiving a subsequent fingerprint template;
(f) calculating a check key for the subsequent fingerprint template on the basis of the character code; and
(g) determining whether the check key matches the unique key, and removing the security corresponding to the electronic device when the check key matches the unique key.

7. The fingerprint recognition method of claim 5, wherein step (c) includes:
(c-1) receiving a reference code; and
(c-2) establishing the unique key on the basis of the character code and the reference code.

8. The fingerprint recognition method of claim 5, wherein step (c) includes:
(c-3) receiving a universal serial bus port number; and
(c-4) establishing the unique key on the basis of the character code and the universal serial bus port number.

9. A fingerprint recognition method for an electronic device, comprising:
(a) receiving a fingerprint template and a unique character code;
(b) determining whether the fingerprint template is already present in a database; and
(c) calculating a check key corresponding to the fingerprint template for fingerprint verification on the basis of the character code when the fingerprint template is already present in the database.

10. The fingerprint recognition method of claim 9, further comprising:
(d) calculating a unique key for the fingerprint template on the basis of the character code so as to establish security for the electronic device when the fingerprint template is not already present in the database; and
(e) determining whether the check key calculated for a subsequently received fingerprint template matches the unique key, and removing the security for the electronic device when the check key matches the unique key.

11. The fingerprint recognition method of claim 9, wherein step (c) further includes:
(c-1) receiving a reference code; and
(c-2) establishing the check key on the basis of the character code and the reference code.

12. The fingerprint recognition method of claim 9, wherein step (c) includes:
(c-3) receiving a universal serial bus port number; and
(c-4) establishing the check key on the basis of the character code and the universal serial bus port number.

13. An electronic device using fingerprint recognition to establish or remove security of protected software, said electronic device comprising:
a recording unit storing a device identification of said electronic device;
a fingerprint-obtaining unit for receiving an initial fingerprint and a subsequent fingerprint, and generating a corresponding initial fingerprint template and a corresponding subsequent fingerprint template; and
a processing unit coupled to said recording unit and said fingerprint-obtaining unit, and comprising a fingerprint recognition system, said fingerprint recognition system comprising:
an input module for receiving the initial fingerprint template, the subsequent fingerprint template, and the device identification,
a computational module calculating a unique key corresponding to the initial fingerprint template on the basis of the device identification during an initial procedure to establish security for the protected software, calculating a check key corresponding to the subsequent fingerprint template on the basis of the device identification during a subsequent procedure, and removing the security for the protected software when the check key matches the unique key, and
a database coupled to said computational module and said input module, and storing the initial fingerprint template and the unique key;
wherein operation of the protected software by said processing unit is restricted when the security is established for the protected software, and is permitted when the security is removed for the protected software by said fingerprint recognition system.

14. The electronic device of claim 13, wherein said recording unit further stores a platform identification, said computational module calculating both the unique key and the check key on the basis of the device identification and the platform identification.

15. The electronic device of claim 13, further comprising a plurality of universal serial bus ports, said fingerprint-obtaining unit being coupled to said processing unit through one of said universal serial bus ports which has a universal serial bus port number associated therewith, said computational module calculating both the unique key and the check key on the basis of the device identification and the universal serial bus port number.

16. The electronic device of claim 13, wherein said electronic device is a notebook computer.
